(19) United States
(12) Patent Application Publication
(10) Pub. No.: US 2012/0248283 A1
(43) Pub. Date: Oct. 4, 2012

(54) BURGLARPROOF LICENSE PLATE FASTENER

(76) Inventor: Antony CHEN, Taichung (TW)

(21) Appl. No.: 13/428,138

(22) Filed: Mar. 23, 2012

(30) Foreign Application Priority Data
Mar. 31, 2011 (TW) 100205709

(51) Int. Cl. B60R 11/00

(52) U.S. Cl. 248/551

(57) ABSTRACT

A burglarproof license plate fastener has a bracket, a burglarproof bolt, a cover and an RFID chip. The bracket has a bracket recess and an elongated mounting hole formed through the bracket recess. The burglarproof bolt is slidably mounted through the mounting hole. The cover is securely connected with the bracket and closes an opening of the bracket recess. The RFID (Radio Frequency Identification) chip is securely mounted in the bracket recess.

### BACKGROUND OF THE INVENTION

1. Field of the Invention

The present invention relates to a burglarproof license plate fastener, and more particularly to a burglarproof license plate fastener providing an excellent protective effect.

2. Description of Related Art

A conventional license plate fastener is simply a bolt. The bolt is mounted through an elongated hole of a license plate and is screwed into a car to securely position the license plate on the car. However, a head of the bolt is exposed from an external environment and is easily rotated. Therefore, the bolt and the license plate are easily dismantled and stolen. Another new license plate needs to be bought and a purchasing cost increases. This is inconvenient.

Moreover, the conventional license plate fastener does not have a chip for storing the identification data of the car. The police have to key in a license number on the license plate for security check but this is inconvenient.

To overcome the shortcomings, the present invention tends to provide a burglarproof license plate fastener to mitigate the aforementioned problems.

### SUMMARY OF THE INVENTION

The main objective of the invention is to provide a burglarproof license plate fastener providing an excellent protective effect.

A burglarproof license plate fastener has a bracket, a burglarproof bolt, a cover and an RFID chip. The bracket has a bracket recess and an elongated mounting hole formed through the bracket recess. The burglarproof bolt is slidably mounted through the mounting hole. The cover is securely connected with the bracket and closes an opening of the bracket recess. The RFID (Radio Frequency Identification) chip is securely mounted in the bracket recess.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a burglarproof license plate fastener in accordance with the present invention;

FIG. 2 is an exploded perspective view of the burglarproof license plate fastener in FIG. 1;

FIG. 3 is a side view in partial section of the burglarproof license plate fastener in FIG. 1;

FIG. 4 is another cross sectional side view of the burglarproof license plate fastener in FIG. 1;

FIG. 5 is an exploded perspective view of the burglarproof license plate fastener in FIG. 1 with a license plate; and

FIG. 6 is a side view in partial section of the burglarproof license plate fastener with the license plate in FIG. 5.

### DETAILED DESCRIPTION OF PREFERRED EMBODIMENT

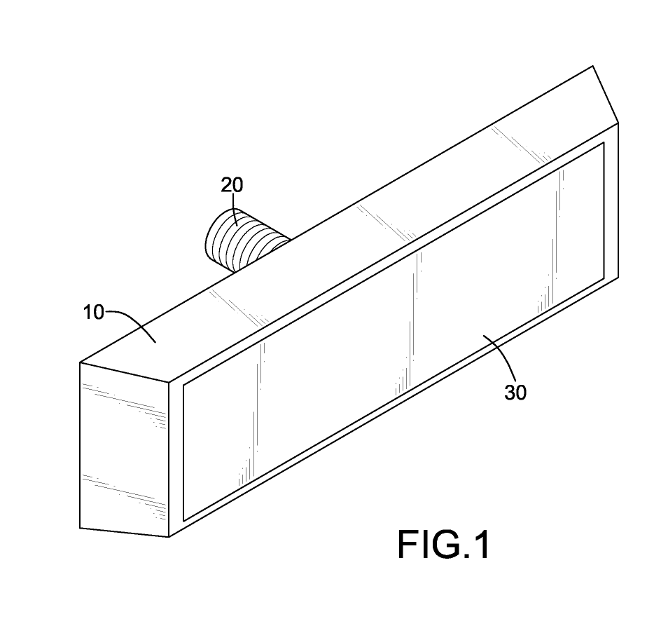

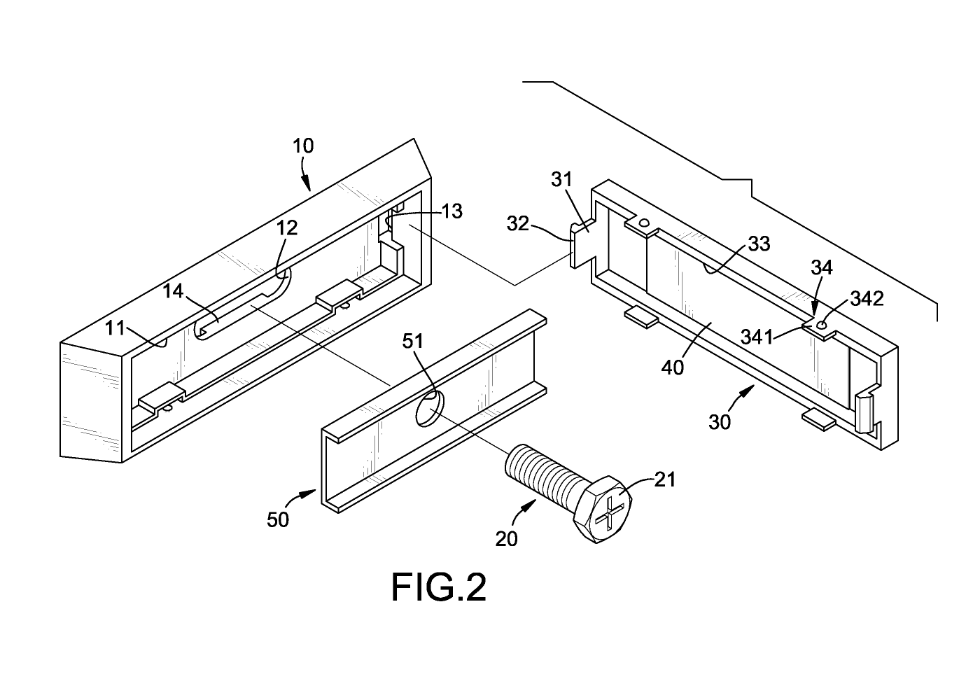

With reference to FIGS. 1 to 2, a burglarproof license plate fastener in accordance with the present invention comprises a bracket 10, a burglarproof bolt 20, a cover 30, an RFID chip 40 and a strengthening plate 50.

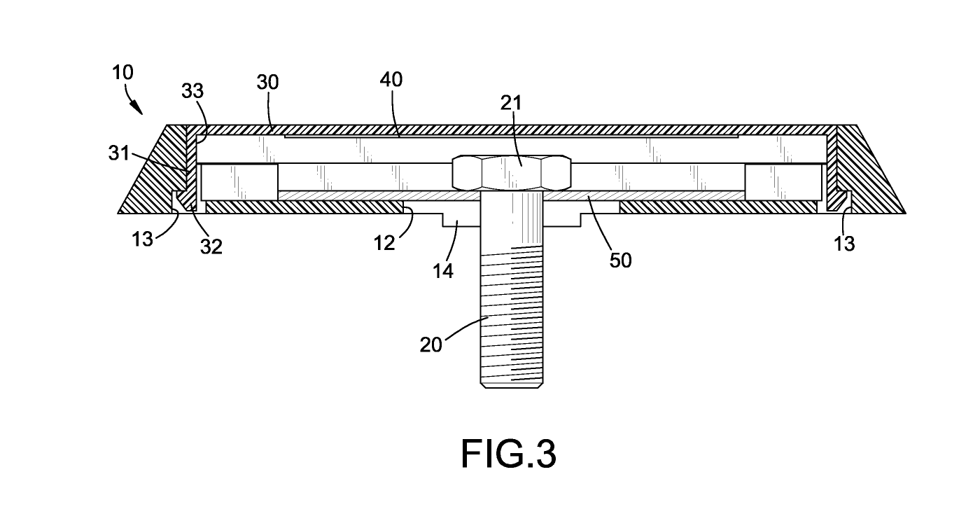

With reference to FIGS. 1 to 3, the bracket 10 is made of plastic and has a bracket recess 11, a mounting hole 12, two cavities 13 and two positioning tabs 14. The bracket recess 11 is formed in the bracket 10, may be rectangular and has a bottom, an opening, two opposite first inner walls and two opposite second inner walls. The opening of the bracket recess 11 is opposite to the bottom of the bracket recess 11.

The mounting hole 12 is elongated, is formed through the bottom of the bracket recess 11 and has an extending direction and two opposite side edges. The side edges of the mounting hole 12 respectively extend along a line parallel to the extending section of the mounting hole 12.

The cavities 13 are respectively formed in the first inner walls of the bracket recess 11.

The positioning tabs 14 are respectively formed on and protrude from the side edges of the mounting hole 12 and are located outside the bracket recess 11.

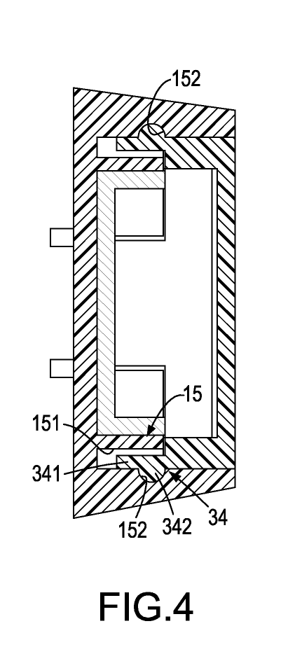

With further reference to FIG. 4, preferably, the bracket 10 has two socket units 15. Each socket unit 15 has two sockets 151 and two sags 152. The sockets 151 of each socket unit 15 are respectively mounted on the second inner walls of the bracket recess 11 and respectively have an opening facing the opening of the bracket recess 11.

The sags 152 of each socket unit 15 are respectively formed in the second inner walls and are respectively adjacent to the openings of the sockets 151 of the socket unit 15.

With reference to FIGS. 1 to 3, the burglarproof bolt 20 is mounted through the bracket 10, is capable of sliding along the extending direction of the mounting hole 12 and has a head 21 located in the bracket recess 11.

The cover 30 is made of plastic, is securely connected with the bracket 10 and closes the opening of the bracket recess 11. The cover 30 has two connecting tabs 31, two hooking sections 32 and a chip recess 33. The connecting tabs 31 are mounted in the bracket recess 11, protrude from the cover 30 and respectively have a distal end. The hooking sections 32 are respectively formed on the distal ends of the connecting tabs 31 and respectively engage the cavities 13 so as to securely connect the cover 30 with the bracket 10. The chip recess 33 is formed in the cover 30 between the connecting tabs 31.

Preferably, the cover 30 has two inserting units 34 respectively connected with the socket units 15. Each inserting unit 34 has two protrusions 341 and two lumps 342. The protrusions 341 of each inserting unit 34 protrude from an edge of the cover 30 and are respectively inserted into the two sockets 151 of a corresponding one of the socket units 15.

The lumps 342 of each inserting unit 34 respectively protrude from the protrusions 341 of the inserting unit 34 and respectively engage the sags 152 of a corresponding one of the socket units 15.

With the inserting units 34 and the socket units 15, the cover 30 is further securely connected with the bracket 10.

The RFID (Radio Frequency Identification) chip 40 is securely mounted in the bracket recess 11 and, preferably, is securely located in a bottom of the chip recess 33.

The strengthening plate 50 is made of metal, is slidably mounted in the bracket recess 11, is squeezed between and by the bottom of the bracket recess 11 and the head 21 of the burglarproof bolt 20 and has a round positioning hole 51. The positioning hole 51 is formed through the strengthening plate 50 and is mounted around the burglarproof bolt 20. Preferably, the strengthening plate 50 has a U-shaped cross section. The strengthening plate 50 serves as a washer to prevent the head 21 from damaging the bracket 10.

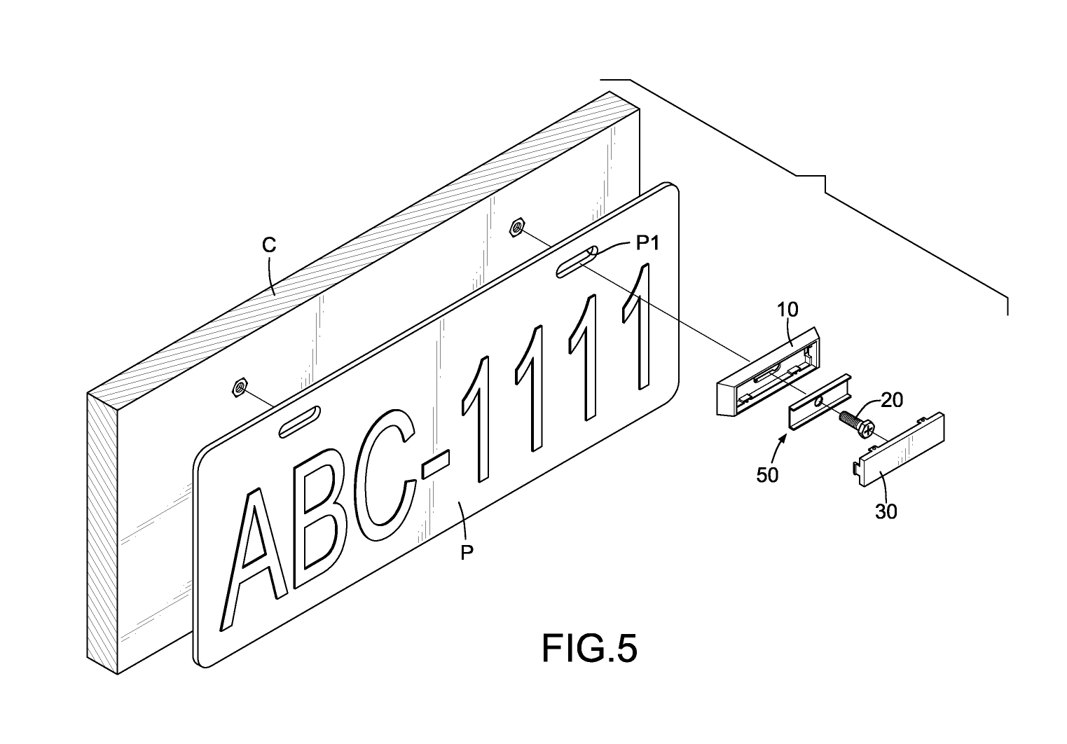

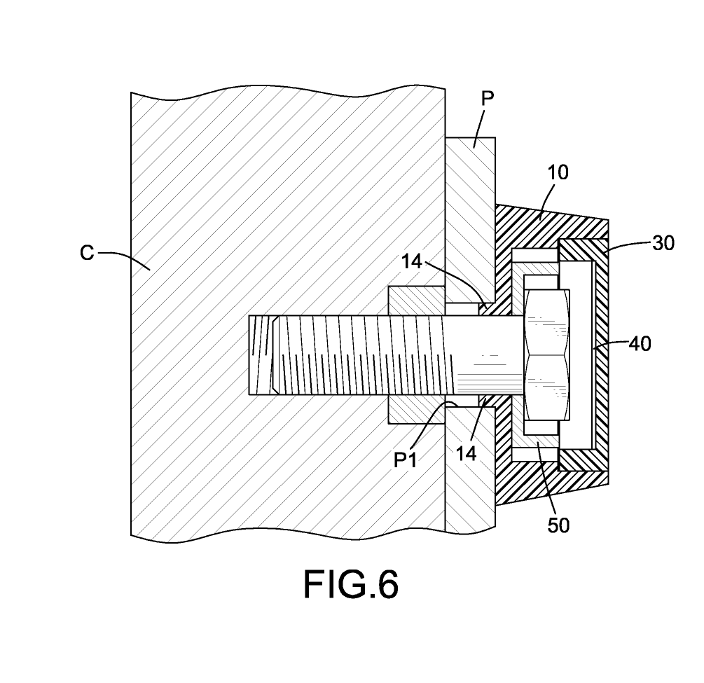

With reference to FIG. 5, FIG. 5 is an exploded perspective view of the burglarproof license plate fastener in accordance with the present invention with a license plate P. The license plate P has two elongated plate holes P1 and a distance between the plate holes P1. Each plate holes P1 is formed through the license plate P and has two opposite side walls. With further reference to FIG. 6, FIG. 6 is a cross sectional side view of the burglarproof license plate fastener with the license plate P in FIG. 5.

In assembling, the positioning tabs 14 are inserted into one of the plate holes P1 and respectively abut the two side walls of the plate hole P1. Therefore, the bracket 10 is slidably mounted in the plate hole P1 and does not rotate relative to the license plate P. Consequently, the bracket 10 can slide for adjustment to match different plate holes P1 of different sizes because the distance between the two plate holes P1 of license plates P1 of different sizes may be different.

The strengthening plate 50 is put in the bracket recess 11 and the burglarproof bolt 20 is mounted through the positioning hole 51, the mounting hole 12 and the plate hole P1 and is then screwed into the car C. Because the strengthening plate 50 is made of metal, the strengthening plate 50 facilitates enhancing the structural strength of the burglarproof license plate fastener in accordance with the present invention, and the burglarproof license plate fastener is not easily destroyed by a burglar.

Besides, the strengthening plate 50 along with the burglarproof bolt 20 can slide along the extending direction of the mounting hole 12 to match different plate holes P1 of different sizes.

Finally, the cover 30 connected with the RFID chip 40 is placed in the bracket recess 11. The connecting tabs 31 are mounted in the bracket recess 11 and the hooking sections 32 respectively engage the cavities 13 for secure positioning. Because the cover 30 closes the opening of the bracket recess 11 to completely cover the head 21 and the cover 30 is difficult to be dismantled, the head 21 is well protected from being rotated and destroyed. Therefore, the license plate P is prevented from being dismantled.

The RFID chip 40 can store identification information of the car C and be detected by the authorities concerned, and this is greatly convenient for security check.

From the above description, it is noted that the present invention has the following advantages:

1. Good Protection:

The cover 30 closes the opening of the bracket recess 11 to completely cover the head 21 and the cover 30 is difficult to be destroyed, so the head 21 is prevented from being rotated and the license plate P is well protected.

2. Quick Detection:

Because the burglarproof license plate fastener has the RFID chip 40 which stores identification information of the car C, the burglarproof license plate fastener can be detected by the authorities concerned for convenient security check.

3. Enhanced Structural Strength:

The strengthening plate 50 is made of metal, so the burglarproof license plate fastener is not easily destroyed by a burglar. The strengthening plate 50 also serves as a washer to prevent the head 21 from damaging the bracket 10.

4. Positioning of the Bracket 10:

With the positioning tabs 14, the bracket 10 is slidably mounted in the plate hole P1 and does not rotate. The bracket 10 is well positioned on the license plate P.

5. Adjustment According to Different License Plates P:

The strengthening plate 50 with the burglarproof bolt 20 can slide along the extending direction of the mounting hole 12 to match different plate holes P1 of different sizes.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A burglarproof license plate fastener comprising:
a bracket having
a bracket recess formed in the bracket and having:
a bottom; and
an opening opposite to the bottom of the bracket recess; and
an elongated mounting hole formed through the bottom of the bracket recess and having an extending direction;
a burglarproof bolt mounted through the mounting hole of the bracket, capable of sliding along the extending direction of the mounting hole and having a head located in the bracket recess;
a cover securely connected with the bracket and closing the opening of the bracket recess; and
an RFID (Radio Frequency Identification) chip securely mounted in the bracket recess.

2. The burglarproof license plate fastener as claimed in claim 1, wherein
the bracket recess has two opposite first inner walls;
the bracket has two cavities respectively formed in the first inner walls of the bracket recess; and
the cover has
two connecting tabs mounted in the bracket recess, protruding from the cover and respectively having a distal end; and
two hooking sections respectively formed on the distal ends of the connecting tabs and respectively engaging the cavities so as to securely connect the cover with the bracket.

3. The burglarproof license plate fastener as claimed in claim 1, wherein
the burglarproof license plate fastener further has a strengthening plate; and
the strengthening plate is slidably mounted in the bracket recess, is squeezed between and by the bottom of the bracket recess and the head of the burglarproof bolt and has
a positioning hole formed through the strengthening plate and mounted around the burglarproof bolt.

4. The burglarproof license plate fastener as claimed in claim 2, wherein
the burglarproof license plate fastener further has a strengthening plate; and
the strengthening plate is slidably mounted in the bracket recess, is pressed between and by the bottom of the bracket recess and the head of the burglarproof bolt and has
a positioning hole formed through the strengthening plate and mounted around the burglarproof bolt.

5. The burglarproof license plate fastener as claimed in claim 3, wherein
the strengthening plate has a U-shaped cross section.

6. The burglarproof license plate fastener as claimed in claim 4, wherein
the strengthening plate has a U-shaped cross section.

7. The burglarproof license plate fastener as claimed in claim 1, wherein
the mounting hole has two elongated and opposite side edges respectively extending along a line parallel to the extending section of the mounting hole; and
the bracket has two positioning tabs respectively formed on and protruding from the side edges of the mounting hole and located outside the bracket recess.

8. The burglarproof license plate fastener as claimed in claim 2, wherein
the mounting hole has two elongated and opposite side edges respectively extending along a line parallel to the extending section of the mounting hole; and
the bracket has two positioning tabs respectively formed on and protruding from the side edges of the mounting hole and located outside the bracket recess.

9. The burglarproof license plate fastener as claimed in claim 3, wherein
the mounting hole has two elongated and opposite side edges respectively extending along a line parallel to the extending section of the mounting hole; and
the bracket has two positioning tabs respectively formed on and protruding from the side edges of the mounting hole and located outside the bracket recess.

10. The burglarproof license plate fastener as claimed in claim 4, wherein the mounting hole has two elongated and opposite side edges respectively extending along a line parallel to the extending section of the mounting hole; and
the bracket has two positioning tabs respectively formed on and protruding from the side edges of the mounting hole and located outside the bracket recess.

11. The burglarproof license plate fastener as claimed in claim 5, wherein the mounting hole has two elongated and opposite side edges respectively extending along a line parallel to the extending section of the mounting hole; and
the bracket has two positioning tabs respectively formed on and protruding from the side edges of the mounting hole and located outside the bracket recess.

12. The burglarproof license plate fastener as claimed in claim 6, wherein the mounting hole has two elongated and opposite side edges respectively extending along a line parallel to the extending section of the mounting hole; and
the bracket has two positioning tabs respectively formed on and protruding from the side edges of the mounting hole and located outside the bracket recess.

13. The burglarproof license plate fastener as claimed in claim 1, wherein the cover has a chip recess formed in the cover and having a bottom where the RFID chip is securely located.

14. The burglarproof license plate fastener as claimed in claim 2, wherein the cover has a chip recess formed in the cover and having a bottom where the RFID chip is securely located.

15. The burglarproof license plate fastener as claimed in claim 3, wherein the cover has a chip recess formed in the cover and having a bottom where the RFID chip is securely located.

16. The burglarproof license plate fastener as claimed in claim 4, wherein the cover has a chip recess formed in the cover and having a bottom where the RFID chip is securely located.

17. The burglarproof license plate fastener as claimed in claim 11, wherein the cover has a chip recess formed in the cover and having a bottom where the RFID chip is securely located.

18. The burglarproof license plate fastener as claimed in claim 12, wherein the cover has a chip recess formed in the cover and having a bottom where the RFID chip is securely located.

19. The burglarproof license plate fastener as claimed in claim 1, wherein the bracket recess is rectangular and has two opposite second inner walls; the bracket has two socket units;
each socket unit has
two sockets respectively mounted on the second inner walls of the bracket recess and respectively having an opening facing the opening of the bracket recess; and
two sags respectively formed in the second inner walls and respectively adjacent to the openings of the sockets of the socket unit; and
the cover has two inserting units respectively connected with the socket units;
each inserting unit has
two protrusions protruding from an edge of the cover and respectively inserted into the two sockets of a corresponding one of the socket units; and
two lumps respectively protruding from the protrusions of the inserting unit and respectively engaging the sags of a corresponding one of the socket units.

20. The burglarproof license plate fastener as claimed in claim 18, wherein the bracket recess has a rectangular cross section and has two opposite second inner walls; the bracket has two socket units;
each socket unit has
two sockets respectively mounted on the second inner walls of the bracket recess and respectively having an opening facing the opening of the bracket recess; and
two sags respectively formed in the second inner walls and respectively adjacent to the openings of the sockets of the socket unit; and
the cover has two inserting units respectively connected with the socket units;
each inserting unit has
two protrusions protruding from an edge of the cover and respectively inserted into the two sockets of a corresponding one of the socket units; and
two lumps respectively protruding from the protrusions of the inserting unit and respectively engaging the sags of a corresponding one of the socket units.
